(19) United States
(12) Patent Application Publication
(10) Pub. No.: US 2011/0148885 A1
(43) Pub. Date: Jun. 23, 2011

(54) APPARATUS AND METHOD FOR EDITING ANIMATION DATA OF VIRTUAL OBJECT UTILIZING REAL MODEL

(75) Inventors: Seong Won RYU, Daejeon (KR); Ki Suk Lee, Daejeon (KR); Hang Kee Kim, Daejeon (KR); Hun Joo Lee, Daejeon (KR); Chang Joon Park, Daejeon (KR)

(73) Assignee: Electronics and Telecommunications Research Institute, Daejeon (KR)

(21) Appl. No.: 12/972,402

(22) Filed: Dec. 17, 2010

(30) Foreign Application Priority Data
Dec. 18, 2009 (KR) 10-2009-0127353
Mar. 18, 2010 (KR) 10-2010-0024316

(51) Int. Cl. G06T 13/00

(52) U.S. Cl. 345/473

(57) ABSTRACT

Disclosed are an apparatus and a method for editing animation data of a virtual object using a model. The animation data editing apparatus using the model according to the embodiment of the present invention allows motion information acquired by measuring a real model to be used by computer graphic software for animation or modeling so as to produce a computer graphic model corresponding to the real model into an animation by being adjusted and modified by a designer on the basis of measured motion information.

### CROSS-REFERENCE TO RELATED APPLICATIONS

This application claims priority under 35 U.S.C. §119 to Korean Patent Application No. 10-2009-0127353, filed on Dec. 18, 2009, and Korean Patent Application No. 10-2010-0024316, filed on Mar. 18, 2010, in the Korean intellectual Property Office, the disclosure of which is incorporated herein by reference in its entirety.

### BACKGROUND OF THE INVENTION

1. Field of the Invention

The present invention relates to an apparatus and a method for editing animation data of a virtual object utilizing a real model(i.e. an object of real world), and more particularly, to an apparatus and a method for granting the same motion to a computer graphic model by extracting operation information from a real model.

2. Description of the Related Art

In the related art, a method of expressing a real-world motion into a virtual world, such as motion capture of a character was primarily used and many studies on a method for editing motion of a virtual object have been in progress.

However, the method for editing motion of the virtual object by using motion of a real model has disadvantages in that a lot of time and much cost are consumed for input and processing and an unrealistic motion is difficult to configure.

Further, in recent years, the number of virtual objects required for contents of a virtual world, a game, etc., has been increasing, thereby causing an increment in a contents production cost.

### SUMMARY OF THE INVENTION

The present invention provides an apparatus and a method for inputting animation data capable of inputting and editing the animation data more rapidly and intuitively than related art by applying information detected from a real model to motion of a computer graphic model.

In order to achieve the above-mentioned object, according to an aspect of the present invention, there is provided an apparatus for editing animation data of a virtual object using a model that includes: a detector detecting a real model; and a data interworker interworking detected information with computer graphic software so as to apply the detected information to a computer graphic model corresponding to the real model.

According to another aspect of the present invention, there is provided a method for editing animation data of a virtual object using a model that includes: detecting a real model; and receiving detected information and interworking the received information with a computer graphic model so as to edit the real model by corresponding the real model to the computer graphic model.

According to an exemplary embodiment of the present invention, it is possible to directly apply an editor's intention to a computer graphic model and rapidly and to intuitively input and edit animation data.

Moreover, it is possible to input various motions including unrealistic motion such as motion of a 3 life-sized character.

Further, it is possible to create high-quality contents and to save a production cost.

### BRIEF DESCRIPTION OF THE DRAWINGS

FIG. 1 is a block diagram describing an apparatus for editing animation data of a virtual object utilizing a real model according to an exemplary embodiment of the present invention; and

FIG. 2 is a diagram for describing a method for editing animation data of a virtual object utilizing a real model according to an exemplary embodiment of the present invention.

### DETAILED DESCRIPTION OF THE PREFERRED EMBODIMENTS

Advantages and characteristics of the present invention, and methods for achieving them will be apparent with reference to embodiments described below in detail in addition to the accompanying drawings. However, the present invention is not limited to the exemplary embodiments to be described below but may be implemented in various forms. Therefore, the exemplary embodiments are provided to enable the present invention to be completely disclosed and the scope of the present invention to be easily understood by those skilled in the art, in which is defined by the scope of the appended claims. Meanwhile, terms used in the specification are used to explain the embodiments and not to limit the present invention. In the specification, a singular type may also be used as a plural type unless stated specifically. “Comprises” and/or “comprising” used the specification mentioned constituent members, steps, operations and/or elements do not exclude the existence or addition of one or more other components, steps, operations and/or elements.

And the term, real model in specification means any kinds of tangible object of the real world including figures, human, animal, etc.

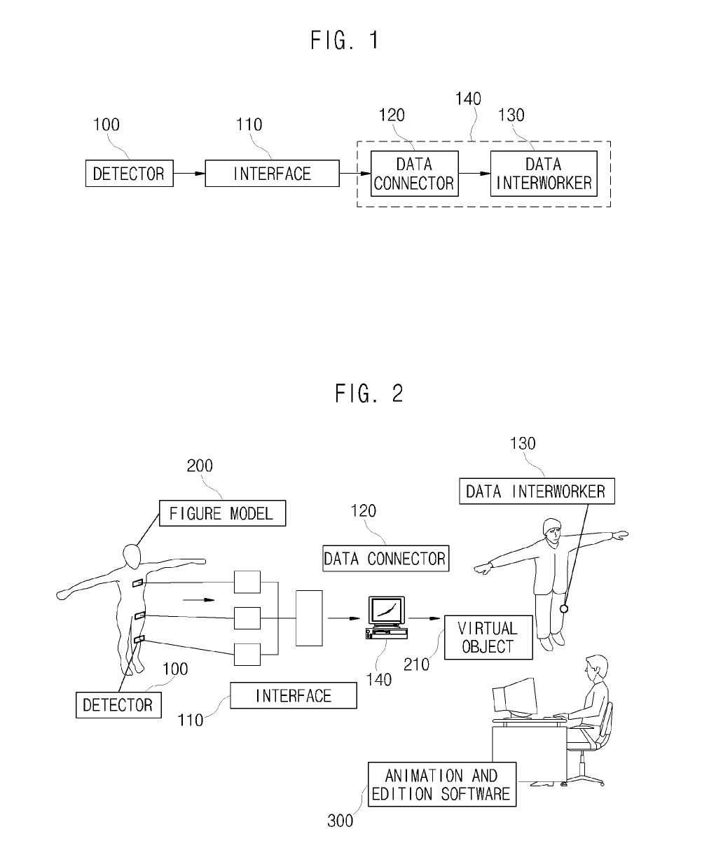

Hereinafter, an apparatus for inputting animation data using a model according to an exemplary embodiment of the present invention will be described. FIG. 1 is a block diagram describing an apparatus for editing animation data of a virtual object utilizing a real model according to an embodiment of the present invention.

As shown in FIG. 1, the animation data editing apparatus using the model according to the exemplary embodiment of the present invention includes a detector 100, an interface 110, a data connector 120, and a data interworker 130.

The detector 100 measures an angle or distance and converts the angle or distance into digital format and thereafter, transmits it to the interface 110. The detector 100 is mounted on or connected to a real model to measure the motion and state of the corresponding model.

The interface 110, which serves to transmit information measured by the detector 100 to a computer 140, transmits the information measured by the detector 100 to the computer 140 through wired/wireless communication such as USB, RS-232, BlueTooth, ZigBee, etc.

Herein, the computer 140 includes the data connector 120 and the data interworker 130.

The data connector 120 stores and manages a value transmitted to the computer 140 and processes the transmitted value to be used in the data interworker 130 afterwards.

The data interworker 130 can apply the motion or state of a real model to a virtual objet by interworking the data processed by the data connector 120 with control software of a computer graphic model edited in computer graphic software for animation or modeling, that is, the virtual object.

As described above, the animation data editing apparatus according to the exemplary embodiment of the present invention has been described with reference to FIG. 1. Hereinafter, an animation data editing method according to an exemplary embodiment of the present invention will be described with reference to FIG. 2. FIG. 2 is a diagram for describing an apparatus for editing animation data of a virtual object utilizing a real model according to an exemplary embodiment of the present invention.

As shown in FIG. 2, a detector 100 receives values measured by measurement instruments such as a variable resistor, a revolution indicator, a distance meter, etc., connected to a real model 200 and provides the measured values to an interface 110.

The interface 110 processes the data value provided from the detector 100 in a format which is processible by a computer 140 and transmits the processed data value to the computer 140.

A data connector 120 manages information transmitted from the interface 110 and processes and stores the transmitted information to be used by a data interworker 130.

The data interworker 130 transfers the data processed by the data connector 120 to a virtual object 210 for animation editing to apply a value measured in a real model 200 to the virtual object 210. That is, the data interworker 130 transfers the data processed by the data connector 120 to computer graphic software controlling the virtual object 210, i.e., animation inputting and editing software 300 to apply the value measured in the real model 200 to the virtual object 210.

As described above, the animation data editing apparatus using the model according to the exemplary embodiment of the present invention can intuitively input and edit the animation data of the virtual object by utilizing the motion of the real model as animation information of the virtual object.

While the present invention has been shown and described in connection with the exemplary embodiments, it will be apparent to those skilled in the art that modifications and variations can be made without departing from the spirit and scope of the invention as defined by the appended claims.

What is claimed is:

1. An apparatus for editing animation data of a virtual object, comprising:
a detector detecting a real model; and
a data interworker interworking detected information with computer graphic software so as to apply the detected information to a computer graphic model corresponding to the real model.

2. The apparatus of claim 1, wherein the detector is mounted on or connected to the real model to detect the motion or state of the model.

3. The apparatus of claim 1, wherein the data interworker applies the motion or state of the model to the computer graphic model by interworking the detected information with control software of the computer graphic model edited in computer graphic software for animation or modeling.

4. The apparatus of claim 1, further comprising:
an interface transmitting the detected information; and
a data connector storing and managing the information transmitted from the interface and processing the corresponding information to be used by the data interworker.

5. The apparatus of claim 1, wherein the detector includes at least one of a variable resistor, a revolution indicator, and a distance meter connected to the model and detects the model through information measured by at least one of the variable resistor, the revolution indicator, and the distance meter

6. The apparatus of claim 5, wherein the detector converts resistance, an angle, or a distance included in the measured information into digital information.

7. The apparatus of claim 6, wherein the interface processes the detected information into information format which is processible by the data connector and transfers the information through wired/wireless communication.

8. A method for editing animation data of a virtual object, comprising:
detecting a real model; and
receiving detected information and interworking the received information with a computer graphic model so as to edit the real model by corresponding the real model to the computer graphic model.

9. The method of claim 8, wherein the detecting detects the motion or state of the real model.

10. The method of claim 8, wherein the interworking interworks the detected information with control software of the computer graphic model edited in computer graphic software for animation or modeling so as to apply the motion or state of the model to the computer graphic model.

11. The method of claim 8, further comprising:
transmitting the detected information; and
storing and managing the transmitted information and processing the information to be used at the interworking.

12. The method of claim 11, wherein the transmitting processes the detected information into information format which is processible at the processing and transfers the information through wired/wireless communication.

13. The method of claim 12, wherein the transmitting uses any one of USB, RS-232, Blue Tooth, and ZigBee.

14. The method of claim 8, wherein the detecting detects the model through information measured by at least of a variable resistor, a revolution indicator, and a distance meter connected to the model.

15. The method of claim 14, wherein the detecting includes converting resistance, an angle, or a distance included in the measured information into digital information.
